(19) United States
(12) Patent Application Publication
(10) Pub. No.: US 2024/0093445 A1
(43) Pub. Date: Mar. 21, 2024

(54) BATTERY POWERED OBJECT-GATHERING APPARATUS

(71) Applicant: Jay Hirshberg, Ft. Myers, FL (US)

(72) Inventors: Jay Hirshberg, Ft. Myers, FL (US); Casey Cotter, Frenchtown, MT (US); Carter Jones, Lima, OH (US)

(21) Appl. No.: 18/524,151

(22) Filed: Nov. 30, 2023

Related U.S. Application Data
(63) Continuation-in-part of application No. 17/171,481, filed on Feb. 9, 2021.
Application No. 17/171,481 is a continuation of application No. 17/017,348, filed on Sep. 10, 2020, now Pat. No. 10,947,685.

(51) Int. Cl. E01H 1/04; A01G 20/43; A47L 11/24; A47L 11/40

(52) U.S. Cl. CPC E01H 1/045; A01G 20/43; A47L 11/24; A47L 11/4013; A47L 11/4041; A47L 11/4069; A47L 11/4027; A47L 11/4063; A47L 2201/04; E01H 1/056

(57) ABSTRACT

An object-gathering apparatus includes a chassis, a plurality of wheels coupled to the chassis, a receptacle coupled to the chassis, a power supply coupled to the chassis, and a sweep assembly coupled to the chassis. The sweep assembly is configured to transfer objects from a surface into the receptacle by mechanical action on the objects, and without the use of negative pressure or vacuum suction acting on the objects during the transfer, in response to powered rotation of the sweep assembly by the power supply. The wheels can be configured to be manually driven or driven by the power supply. The power supply can include a battery clip affixed to the chassis and accessible from an exterior of the object-gathering apparatus. The sweep assembly can be coupled to a sweep assembly housing that is coupled to the chassis and configured for vertical adjustment relative to the chassis.

### CROSS REFERENCE TO RELATED APPLICATIONS

This application is a continuation-in-part of, and claims priority to, U.S. application Ser. No. 17/171,481, filed Feb. 9, 2021, entitled “OBJECT-GATHERING APPARATUS”, which is a continuation of, and claims priority to, U.S. application Ser. No. 17/017,348, filed Sep. 10, 2020, now U.S. Pat. No. 10,947,685, issued Mar. 16, 2021, entitled “OBJECT-GATHERING APPARATUS”, the disclosures of all of which are incorporated by reference in their entirety.

### FIELD

The field of the disclosure relates generally to gathering objects from a surface and, more particularly, to an apparatus for gathering a selected category of objects from a surface within a bounded operational area.

### BACKGROUND

There are many known environments in which it is desirable to gather or collect a certain category of objects distributed on a surface, such as on the ground or an indoor floor surface. At least some known systems apply negative pressure or suction to gather such objects from a surface. However, such systems are inefficient in cases in which the desired category of objects is interspersed with other material that is not desired to be collected (“debris”), and/or the surface is of a type that interferes with, or would be undesirably altered or damaged by, vacuum-based collection of the objects. In addition, at least some known systems apply water jets to scour the objects from the surface, and collect the objects with a cylindrical brush. Again, such systems are inefficient in cases in which the desired category of objects is interspersed with unwanted debris, and/or the surface is of a type that would be undesirably altered or damaged by water-jet-based collection of the objects.

One non-limiting example of such an environment is an indoor and/or outdoor shooting competition field, in which shooting targets and various obstacles are arranged on a natural surface. Throughout the course of a competition or practice round on the field, brass ammunition casings are ejected onto the ground across the field. It is desirable to collect these brass casings, which can be reused to re-manufacture ammunition or otherwise recycled. However, the casings may become entangled in grass or other debris and/or partially embedded in the ground. Known systems are ineffective at gathering the casings with minimal intermixing of dirt, grass, or other debris, while leaving the surface in use-ready condition.

Accordingly, an apparatus that enables selective collection of a desired category of objects from a surface, with reduced impact to the surface, would find utility.

### SUMMARY

In one aspect, an object-gathering apparatus is provided. The apparatus includes a chassis, a plurality of wheels coupled to the chassis and configured to be manually driven over a surface, a receptacle coupled to the chassis, a power supply coupled to the chassis, and a sweep assembly coupled to the chassis. The sweep assembly is configured to transfer objects from the surface into the receptacle by mechanical action on the objects, and without use of negative pressure or vacuum suction acting on the objects during the transfer, in response to powered rotation of the sweep assembly by the power supply.

In another aspect, an object-gathering apparatus is provided. The apparatus includes a chassis, a plurality of wheels coupled to the chassis and configured to traverse a surface, a receptacle coupled to the chassis, and a battery clip affixed to the chassis and accessible from an exterior of the object-gathering apparatus. A rechargeable battery is removably insertable into the battery clip. The apparatus also includes a sweep assembly coupled to the chassis and configured to transfer objects from the surface into the receptacle by mechanical action on the objects, and without use of negative pressure or vacuum suction acting on the objects during the transfer, in response to powered rotation of the sweep assembly by the rechargeable battery

In another aspect, an object-gathering apparatus is provided. The apparatus includes a chassis, a plurality of wheels coupled to the chassis and configured to traverse a surface, a receptacle coupled to the chassis, a sweep assembly housing coupled to the chassis and configured for vertical adjustment relative to the chassis, and a sweep assembly coupled to the sweep assembly housing. The sweep assembly is configured to transfer objects from the surface into the receptacle by mechanical action on the objects, and without use of negative pressure or vacuum suction acting on the objects during the transfer, in response to rotation of the sweep assembly.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of an example embodiment of a self-propelled object-gathering apparatus on a surface.

FIG. 2 is a top view of the apparatus of FIG. 1.

FIG. 3 is a side view of the apparatus of FIG. 1.

FIG. 4 is a perspective view of the apparatus of FIG. 1 operating in an example environment.

FIG. 5 is a perspective view of another example embodiment of an object-gathering apparatus.

FIG. 6A is a side view of a portion of the apparatus of FIG. 5 in a forward-moving configuration.

FIG. 6B is a side view of a portion of the apparatus of FIG. 5 in a backward-moving configuration.

FIG. 6C is a schematic view, taken normal to a longitudinal axle axis, of a portion of an example ratchet mechanism that can be used with the apparatus of FIG. 5.

FIG. 7 is a perspective view of another example embodiment of an object-gathering apparatus.

FIG. 8 is a front view of the apparatus shown in FIG. 7.

Corresponding reference characters indicate corresponding parts throughout the drawings.

### DETAILED DESCRIPTION

The examples described herein include a self-propelled object-gathering apparatus configured to traverse a surface and collect a category of objects. The examples include a rotating sweep assembly configured to transfer the objects from the surface into a receptacle by applying mechanical force to the objects. The examples also include an on-board control system programmed to detect a bounded operational area and to guide the apparatus within the bounded operational area. For example, the guidance system recognizes a perimeter of the operational area using one or more of Global Positioning System (GPS) signals, a beacon signal emanating from the center of the operational area, and radio frequency (RF) markers positioned along a boundary of the operational area. The control system employs any suitable surface-coverage algorithm to cause the apparatus to sweep substantially all navigable portions of the surface within the bounded operational area.

In certain examples, a bottom wall of the collection receptacle includes openings sized to retain the objects of interest, while allowing smaller-sized debris to pass through back to the surface, or to a secondary debris receptacle positioned beneath the collection receptacle. In some such examples, the collection receptacle is coupled to a vibration element that causes the bottom wall to sift the debris from the objects of interest. Additionally or alternatively, the apparatus includes a tiller assembly configured to dislodge objects from, for example, a turf surface and/or guide the objects on the surface into a path of the sweep assembly.

Moreover, in some examples, a drive system of the apparatus includes sets of wheels on each side of the apparatus, and each set has an independent suspension, enabling the apparatus to traverse over obstacles (e.g., landscape elements, man-made obstacles, or relatively larger debris) while maintaining the sweep assembly in operational proximity to the surface to collect the objects of interest. Additionally or alternatively, the apparatus includes a sensor configured to detect impassable obstacles (e.g., fences or walls) located within the bounded operational area, and the control system is programmed to navigate around detected obstacles. In some such examples, the apparatus includes actuators configured to raise the sweep assembly and/or the tiller assembly while, for example, the apparatus is navigating around obstacles or returning to a home base after sweeping operations are completed.

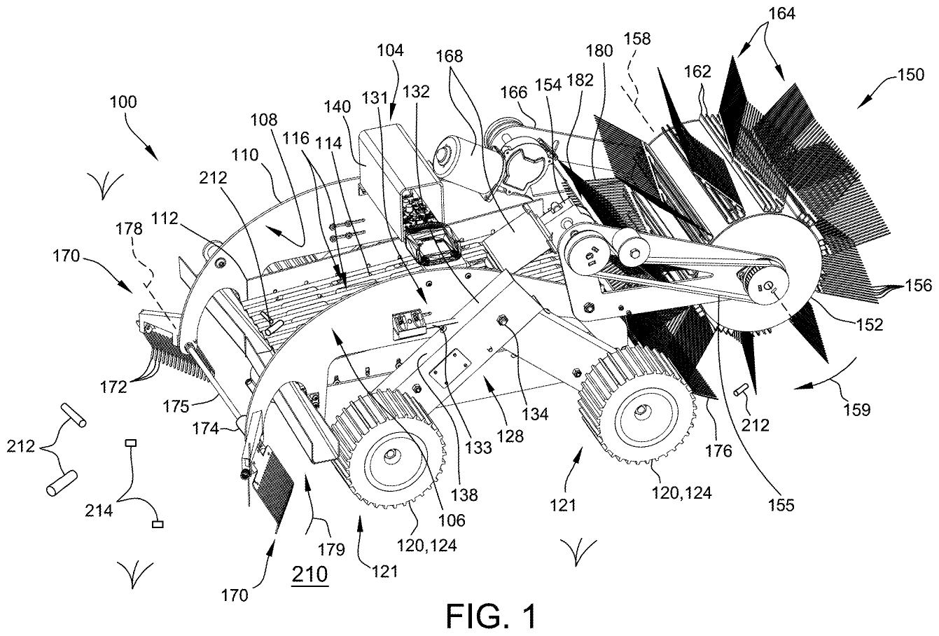

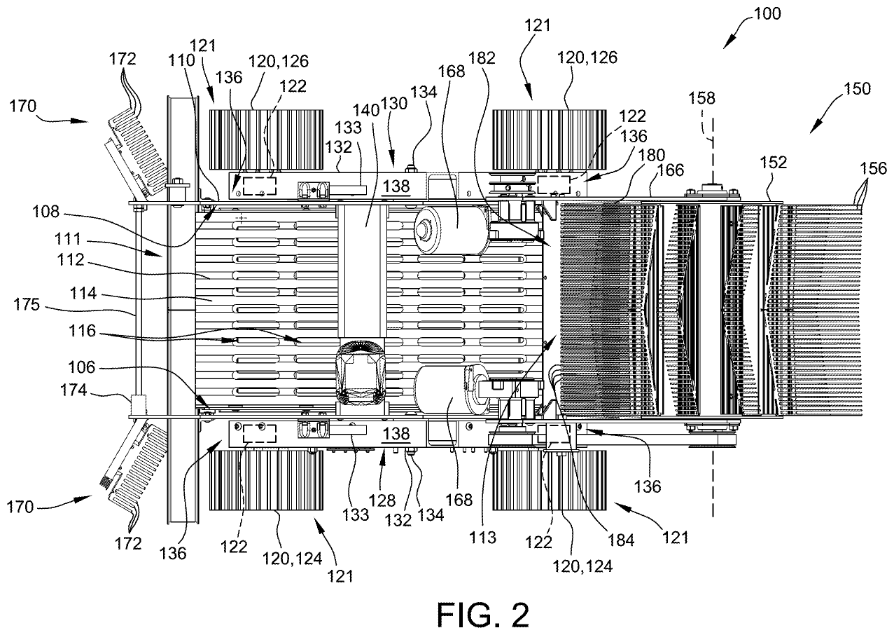

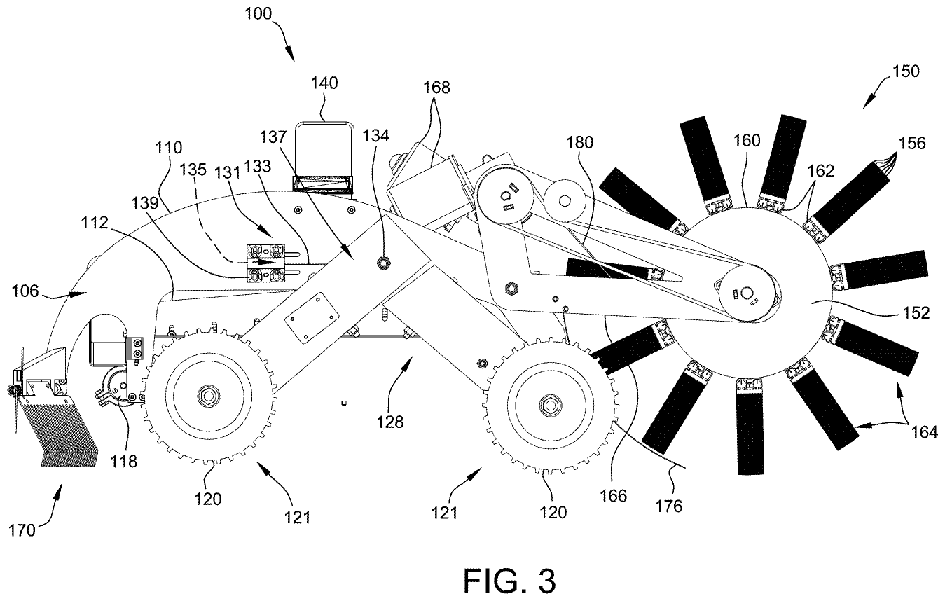

FIG. 1 is a perspective view of an example embodiment of a self-propelled object-gathering apparatus 100 on a surface 210. FIG. 2 is a top view, and FIG. 3 is a side view, of apparatus 100. FIG. 4 is a perspective view of apparatus 100 operating in an example environment 200 that includes surface 210. With reference to FIGS. 1-4, apparatus 100 is configured to operate autonomously in environment 200 and collect a category of objects 212 from surface 210. In the example discussed herein, objects 212 are brass ammunition casings. Alternatively, however, objects 212 are of any type suitable for collection by apparatus 100 as described herein. Also in the example, surface 210 is a natural turf surface, and environment 200 is an outdoor shooting competition field. Alternatively, surface 210 is any type of surface, and/or environment 200 is any type of environment, suitable for operation of apparatus 100 as described herein.

In the illustrated example, apparatus 100 includes a chassis 110. For example, chassis 110 is a rigid frame that provides structural support for the other elements of apparatus 100. Chassis 110 may be formed from a metallic or hard plastic material, for example.

Apparatus 100 further includes a control system 140 coupled to chassis 110. In the illustrated example, control system 140 is housed on a bridge portion 104 of chassis 110 that extends between opposing first and second sides 106, 108 of chassis 110. Alternatively, control system 140 is coupled to chassis 110 in any suitable fashion that enables apparatus 100 to function as described herein. Control system 140 is programmed to detect a bounded operational area 220 within environment 200, and to guide apparatus 100 within bounded operational area 220. In some examples, control system 140 employs a suitable surface-coverage algorithm to cause apparatus 100 to sweep substantially all navigable portions of surface 210 within bounded operational area 220. Such surface-coverage algorithms are known in the art, and need not be described here.

Apparatus 100 further includes a drive system 121 coupled to chassis 110 and configured to traverse apparatus 100 over surface 210. In the illustrated example, drive system 121 comprises a plurality of wheels 120. Alternatively, drive system 121 includes any suitable mechanism that enables apparatus 100 to traverse surface 210, such as at least one caterpillar track. In the illustrated example, the plurality of wheels 120 includes four wheels 120. Alternatively, the plurality of wheels 120 includes any suitable number of wheels 120 that enables apparatus 100 to function as described herein.

In some examples, drive system 121 includes at least one wheel motor 122 coupled to the chassis and drivingly coupled to at least one of the plurality of wheels 120. More specifically, in some examples, the at least one wheel motor 122 is in communication with control system 140, and control system 140 is programmed to selectively operate the at least one wheel motor 122 to traverse apparatus 100 over surface 210 within bounded operational area 220. For example, control system 140 is programmed to detect a current position of apparatus 100 with respect to bounded operational area 220, as described in more detail below, and to selectively drive the at least one wheel motor 122 in accordance with the current position of apparatus 100 and the surface-coverage algorithm.

In the illustrated example, as best seen in FIG. 2, the at least one wheel motor 122 includes a respective wheel motor 122 drivingly coupled to each wheel 120. In other words, in the illustrated example, every wheel 120 is powered by a separate respective wheel motor 122, and each wheel motor 122 is separately controlled by control system 140. In some cases, the use of a separately controlled wheel motor 122 for each wheel 120 enhances a maneuverability of apparatus 100. For example, changing a forward direction of travel of apparatus 100 is accomplished by driving wheel motors 122 on opposing sides 106, 108 of chassis 110 in opposite rotational directions. This arrangement avoids a need for a steering system to change the orientation of the axis of rotation of the wheels 120 relative to the chassis. Alternatively, the at least one wheel motor 122 includes fewer wheel motors 122 than the number of wheels 120. For example, only the two front wheels 120 are coupled to respective wheel motors 122. For another example, a single wheel motor 122 is used to drive multiple wheels 120.

In some examples, drive system 121 includes a first set 124 of wheels 120 positioned adjacent to first side 106 of chassis 110, and a second set 126 of wheels 120 positioned adjacent to second side 108 of chassis 110, and apparatus 100 further includes a first suspension assembly 128 coupling the first set 124 to chassis 110 and a second suspension assembly 130 coupling the second set 126 to chassis 110. More specifically, first and second suspension assemblies 128, 130 are independent, enabling apparatus 100 to traverse over obstacles while maintaining sweep assembly 150 (described in more detail below) in operational proximity to surface 210 to collect objects 212. For example, if one rear wheel 120 is elevated by a rock or hump of turf protruding from surface 210, the independent suspensions allow sweep assembly 150 to remain substantially in operational position to collect objects 212.

In the illustrated example, first suspension assembly 128 includes a rocker arm 132 that includes a pivot 134 and two ends 136. More specifically, rocker arm 132 extends in an inverted V-shape from pivot 134, at the point of the V-shape, to the two ends 136. Pivot 134 is coupled to first side 106 of chassis 110, and a respective wheel 120 of first set 124 is coupled to each of the two ends 136. Rocker arm 132 is substantially rigid and rotatable about pivot 134 within a plane defined by the V-shape, such that upward movement of either wheel 120 in first set 124 results in relative downward movement in the other wheel 120 of first set 124. In some examples, implementation of first suspension assembly 128 using rocker arm 132 enables apparatus 100 to traverse over obstacles while maintaining sweep assembly 150 in operational proximity to surface 210 to collect objects 212. Alternatively, first suspension assembly 128 is configured in any suitable fashion that enables apparatus 100 to function as described herein.

In some examples, first suspension assembly 128 further includes a biasing element 131 coupled between chassis 110 and rocker arm 132. Biasing element 131 is configured to return first set 124 of wheels 120 to a common horizontal plane, for example after traversal of a small obstacle has displaced rocker arm 132 about pivot 134. In some examples, biasing element 131 facilitates smoother operation of sweep assembly 150 by damping excessive movement of rocker arm 132.

In the illustrated example, rocker arm 132 includes an upper surface 138 extending between pivot 134 and a first of the two ends 136. In addition, as best seen in FIG. 3, biasing element 131 includes a resilient strip 133 that includes a first end 135 fixed to first side 106 of chassis 110, and an opposite, free second end 137 configured to urge upper surface 138 downward in response to upward displacement of the first end 136 of the rocker arm. For example, resilient strip 133 is a flat strip of metal that resiliently flexes in response to upward movement of upper surface 138. Alternatively, biasing element 131 is implemented in any suitable fashion that enables first suspension assembly 128 to function as described herein.

In some examples, first suspension assembly 128 further includes an adjustable mount 139 fixed to first side 106 of chassis 110. Adjustable mount 139 is operable to affix first end 135 of resilient strip 133 at any of a plurality of positions relative to pivot 134. For example, adjustable mount 139 is implemented as a clamp configured to sandwich first end 135 therein. Affixing first end 135 closer to a front end 111 of chassis 110 results in relatively less spring force applied to upper surface 138 by free second end 137, while affixing first end 135 closer to a rear end 113 of chassis 110 results in relatively more spring force applied to upper surface 138 by free second end 137. Accordingly, adjustable mount 139 enables easy adjustment of a return force applied by biasing element 131. Alternatively, resilient strip 133 is mounted to chassis 110 in any suitable fashion that enables apparatus 100 to function as described herein.

Apparatus 100 also includes a receptacle 112 coupled to chassis 110, and a sweep assembly 150 coupled to chassis 110 and rotatable with respect to chassis 110. Sweep assembly 150 is configured to transfer objects 212 from surface 210 into receptacle 112 by mechanical action on the objects in response to rotation of sweep assembly 150. In some examples, the ability of apparatus 100 to collect and deposit objects 212 in receptacle 112 via solely mechanical action on objects 212, without use of negative pressure or vacuum suction or water jets to move the objects as in conventional systems, avoids alteration or damage to surface 210 and leaves surface 210 in a use-ready condition.

In the illustrated example, sweep assembly 150 is located adjacent to rear end 113 of chassis 110. Alternatively, sweep assembly 150 is located at any suitable location with respect to chassis 110 that enables apparatus 100 to function as described herein.

In some examples, sweep assembly 150 includes a roller element 152 coupled to chassis 110 and rotatable with respect to chassis 110, a sweep assembly motor 154 coupled to chassis 110 and drivingly coupled to roller element 152 to cause rotation of roller element 152, and bristles 156 extending outward from roller element 152 and configured to urge objects 212 from surface 210 into receptacle 112 via direct mechanical contact in response to the rotation of roller element 152. Alternatively, sweep assembly 150 is implemented in any suitable fashion that enables apparatus 100 to function as described herein.

In some examples, roller element 152 is rotatable about an axis 158 generally parallel to surface 210 and extending generally perpendicular to first and second sides 106, 108 of chassis 110. For example, roller element 152 has a cylindrical shape, and a longitudinal axis of the cylinder defines axis 158. Roller element 152 rotates about axis 158 in a direction 159 that causes bristles 156 underneath roller element 152 to contact, or nearly contact, surface 210 and sweep objects 212 lying thereon towards receptacle 112. Alternatively, axis 158 has any suitable orientation, and/or roller element 152 has any suitable shape, that enables apparatus 100 to function as described herein.

In some examples, bristles 156 are arranged on roller element 152 in circumferentially spaced rows 164. For example, in the illustrated embodiment, the rows 164 have a V-shape oriented to scoop objects 212 towards receptacle 112, and then allow objects 212 to tumble out under the force of gravity as each row 164 elevates above receptacle 112. Moreover, in some examples, sweep assembly 150 further includes tracks 162 defined on, or coupled to, a circumferential outer surface 160 of the roller element, and bristles 156 are affixed to tracks 162. In particular, replacement of worn bristles 156 is accomplished by sliding the worn bristles 156 laterally out of the corresponding tracks 162, and sliding new bristles 156 into the tracks. Alternatively, bristles 156 are coupled to roller element 152 in any suitable fashion and spacing that enables apparatus 100 to function as described herein

Bristles 156 may be selected to have a flexibility that avoids significant scraping damage to surface 210, while being sufficiently stiff to capture the desired category of objects 212 during rotation of roller element 152. In some examples, bristles 156 having different flexibility are selected for different combinations of surface 210 and objects 212. In other words, bristles 156 having a first flexibility tailored for collecting relatively smaller brass ammunition casings from a natural turf surface may be swapped out for bristles 156 having a second flexibility tailored for collecting relatively larger brass ammunition casings from an artificial surface. As described above, tracks 162 are used in some examples to facilitate swapping out of bristles 156 adapted for different use conditions.

In some examples, apparatus 100 is configured to raise sweep assembly 150 away from surface 210 during certain operating conditions when collection of objects 212 is unnecessary, such as transit to or from a docking station (not shown) or while navigating around obstacles 260. In some cases, raising sweep assembly 150 reduces drag or interference that may be caused by sweep assembly 150 during non-collecting operations. In the illustrated example, apparatus 100 includes a rigid linkage 166 that couples roller element 152 to chassis 110; and at least one linkage actuator 168 coupled between linkage 166 and chassis 110. Linkage actuator 168 is in communication with control system 140, which is further programmed to selectively operate linkage actuator 168 to elevate roller element 152, and hence elevate bristles 156 away from surface 210, for example in response to control system 140 commanding transit to or from a docking station or detecting and navigating around an obstacle 260. Likewise, control system 140 is further programmed to lower roller element 152, and hence deploy bristles 156 into contact or near-contact with surface 210, when the non-collecting mode of operations has ended. Alternatively, apparatus 100 is configured to selectively raise and lower sweep assembly 150 in any suitable fashion.

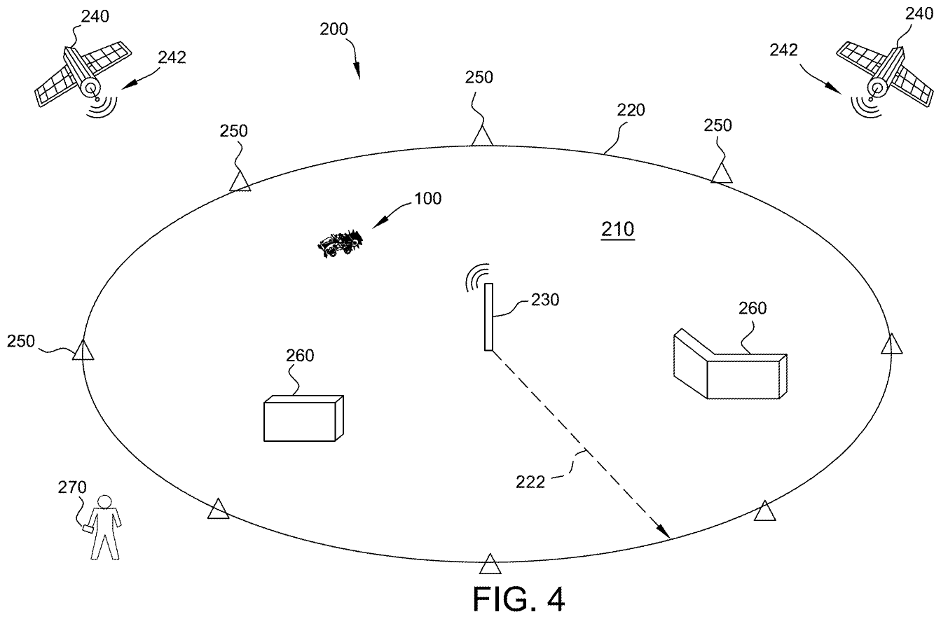

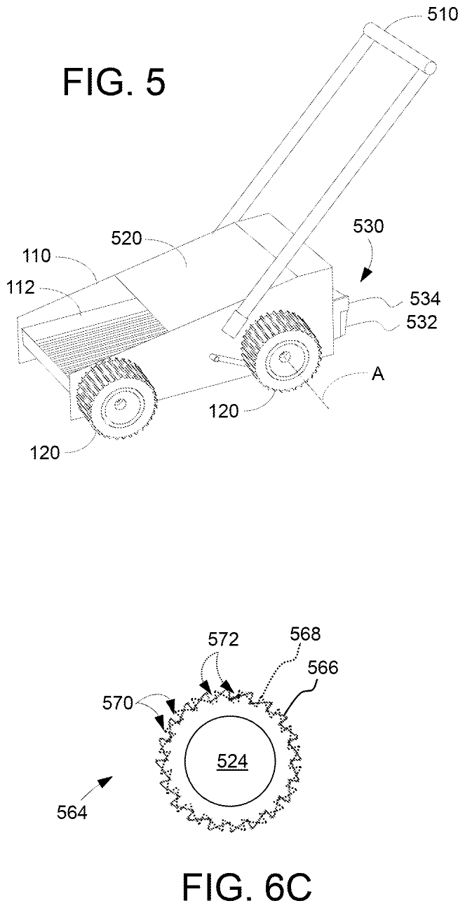

In some examples, sweep assembly motor 154 is coupled to chassis 110 indirectly via linkage 166. In the illustrated example, sweep assembly motor 154 is mounted on linkage 166. Alternatively, sweep assembly motor 154 is mounted in any suitable location that enables sweep assembly 150 to function as described herein. In certain examples, sweep assembly motor 154 is configured to convert electrical energy (e.g., from an on-board battery, such as battery 532 shown in FIG. 5) into mechanical action on objects 212 via rotation of roller element 152. In the illustrated example, sweep assembly motor 154 is configured to rotate roller element 152 via a drive belt 155. Alternatively, sweep assembly motor 154 is configured to convert electrical energy into mechanical action on objects 212 in any suitable fashion that enables apparatus 100 to function as described herein. As noted above, in some examples, the use of solely electro-mechanical systems to collect objects 212, without use of negative pressure or vacuum suction or water jets to move the objects as in conventional systems, avoids alteration or damage to surface 210 and leaves surface 210 in a use-ready condition.

In some examples, apparatus 100 further includes a ramp 176 coupled to chassis 110 between sweep assembly 150 and receptacle 112. Ramp 176 is configured to cooperate with bristles 156 to guide objects 212 into receptacle. 112. In the illustrated example, ramp 176 extends from rear end 113 of chassis 110, rearwards and downwards into contact, or near-contact, with surface 210. As apparatus 100 moves forward, ramp 176 is configured to flex in a rearward direction to allow objects 212 on surface 210 to pass underneath ramp 176 and into a position for collection by sweep assembly 150.

In the illustrated example, ramp 176 has an arcuate profile complementary to a path traveled by the tips of bristles 156 as bristles 156 rotate upwards from underneath roller element 152 towards chassis 110. Thus, ramp 176 cooperates with bristles 156 to retain collected objects 212 until they are in position for dropping into receptacle 112. Moreover, the arcuate profile enables ramp 176 to trail along surface 210 in a fashion that reduces interference with surface 210 and displacement of objects 212 from the path of sweep assembly 150. Alternatively, ramp 176 has any suitable configuration that enables apparatus 100 to function as described herein.

In some examples, apparatus 100 further includes a screen 180 coupled to chassis 110. Screen 180 extends from a first end 182 elevated above receptacle 112 and rearward towards roller element 152. More specifically, screen 180 is oriented to deflect objects 212 elevated by bristles 156 towards receptacle 112. In other words, screen 180 captures objects 212 that may be “popped” away from surface 210 by bristles 156, and facilitates clearing any objects 212 that may not have fallen from bristles 156 into receptacle 112 under the force of gravity alone.

In the illustrated example, screen 180 comprises screen bristles 184 that are interdigitated with bristles 156 of sweep assembly 150. Bristles 156 of sweep assembly 150 pass between stationary screen bristles 184 during rotation of sweep assembly 150. Interdigitated screen bristles 184 facilitate clearing of objects 212 from bristles 156. Alternatively, screen 180 has any suitable configuration that enables sweep assembly 150 to function as described herein.

In some examples, receptacle 112 includes a bottom wall 114 that includes openings 116 extending therethrough. More specifically, openings 116 are sized to prevent passage of objects 212 therethrough, and permit passage of debris 214 that has a size smaller than a size of the objects 212 therethrough. Debris 214 generally includes any material on surface 210, other than the desired category of objects 212, that may be captured and deposited into receptacle 112 by sweep assembly 150. Debris 214 may include, for example but without limitation, dirt particles from a natural turf surface or fibers from an artificial surface. Openings 116 configured to enable separation of debris 214 from collected objects 212 facilitates more efficient collection and, in some cases, more efficient re-use or recycling of objects 212. Alternatively, receptacle 112 does not include openings 116 in bottom wall 114.

In some examples, apparatus 100 is configured to allow debris 214 passed through openings 116 to fall directly back to surface 210. In other examples, apparatus 100 includes a secondary receptacle (not shown) directly beneath openings 116 to capture debris 214 passed through openings 116 for subsequent disposal.

In the illustrated example, openings 116 have a slotted shape with a width slightly less than a characteristic dimension of the desired category of objects 212 (e.g., a width of ammunition casings sought to be collected). Alternatively, openings 116 have any suitable shape that enables receptacle 112 to function as described herein.

In some examples, apparatus 100 further includes a vibration element 118 coupled between chassis 110 and receptacle 112. More specifically, bottom wall 114 is configured to sift debris 214 from objects 212 and through openings 116 in response to operation of vibration element 118. In the illustrated example, vibration element 118 is coupled between front end 111 of chassis 110 and bottom wall 114. Alternatively, vibration element 118 is coupled at any suitable location that enables receptacle 112 to function as described herein.

In some examples, vibration element 118 is in communication with control system 140, which is further programmed to selectively operate vibration element 118 during collection operations, and to selectively deactivate vibration element 118 during non-collection operations, such as when apparatus 100 is in transit to or from a docking station or navigating around an obstacle. Alternatively, vibration element 118 is not selectively operable.

In some examples, receptacle 112 is removable from, and re-installable into, apparatus 100 by hand for ease of emptying collected objects 212. For example, receptacle 112 is receivable into chassis 110 in a snap fit, or is locked into place with a hand-operated latch (not shown). Alternatively, receptacle 112 is not removable from and re-installable into apparatus 100 by hand.

In some examples, bottom wall 114 is sloped downward in a direction away from sweep assembly 150. The downward slope tends to cause collected objects 212 to migrate away from a portion of receptacle 112 adjacent to sweep assembly 150, clearing space for additional objects 212 to be deposited from sweep assembly 150 into that portion of receptacle 112. In the illustrated example, sweep assembly 150 is located at rear end 113 of chassis 110, and bottom wall 114 slopes downward towards front end 111 of chassis 110, causing objects 212 to migrate toward front end 111 and clearing space for additional objects 212 to be deposited near rear end 113. Alternatively, bottom wall 114 has any suitable orientation that enables receptacle 112 to function as described herein.

In some examples, apparatus 100 further includes a tiller assembly 170 configured to guide objects 212 on surface 210 into a path of sweep assembly 150 in response to forward motion of apparatus 100. In some cases, tiller assembly 170 increases an efficiency of collection of objects 212 by moving additional objects 212 into a path of sweep assembly 150, and/or by dislodging objects 212 that have become partially embedded in surface 210. For example, in cases where surface 210 is natural turf, objects 212 may become entangled in grass or embedded in dirt after being stepped on.

In some examples, tiller assembly 170 includes a plurality of tines 172 configured to abut surface 210 and oriented to urge objects 212 into the path of sweep assembly 150. In the illustrated example, tines 172 are positioned at front end 111 of chassis 110 in two sets, with each set in front of a path of wheels 120 (with respect to forward motion of apparatus 100) on a respective side 106, 108 of chassis 110. Each set of tines 172 is oriented obliquely inward and rearward to funnel objects 212 underneath chassis 110 and into the path of sweep assembly 150. Thus, in the illustrated example, tines 172 increase an effective collection width of apparatus 100 and facilitate preventing objects 212 from being run over by wheels 120 and consequently embedded in surface 210. Alternatively, tines 172 are positioned and oriented in any suitable fashion that enables apparatus 100 to function as described herein.

In some examples, apparatus 100 is configured to raise tiller assembly 170 away from surface 210 during certain operating conditions when collection of objects 212 is unnecessary, such as transit to or from a docking station (not shown) or while navigating around obstacles 260. In some cases, raising tiller assembly 170 reduces drag or interference that may be caused by tiller assembly 170 during non-collecting operations. In some such examples, tiller assembly 170 further includes a tiller actuator 174 coupled between chassis 110 and plurality of tines 172. Tiller actuator 174 is in communication with control system 140, which is further programmed to selectively operate tiller actuator 174 to retract tines 172 away from surface 210, for example in response to control system 140 commanding transit to or from a docking station or detecting and navigating around an obstacle 260. Likewise, control system 140 is further programmed to deploy tines 172 into abutment with surface 210 when the non-collecting mode of operations has ended.

In the illustrated example, tiller assembly 170 further includes a connecting rod 175 coupled to chassis 110, and the two sets of tines 172 as discussed above are mounted on opposite ends of connecting rod 175. Tiller actuator 174 is fixed to chassis 110 and operable to rotate connecting rod 175 such that tines 172 rotate rearward and upward, as shown by arrow 179 in FIG. 1, to implement retraction of tines 172 away from surface 210. Tiller actuator 174 is likewise operable to rotate connecting rod 175 such that tines 172 rotate forward and downward, opposite to arrow 179, to implement deployment of tines 172 into abutment with surface 210. Alternatively, apparatus 100 is configured to selectively raise and lower tiller assembly 170 in any suitable fashion.

In some examples, apparatus 100 further includes a suitable cover, which is not shown in FIGS. 1-4 for ease of illustration of the features of apparatus 100. For example, the cover is coupled to chassis 110 and is configured to extend over receptacle 112 and sweep assembly 150.

With particular reference to FIG. 4, in some examples, control system 140 is programmed to detect bounded operational area 220 with reference to a local beacon 230 configured to emit signals that are wirelessly detectable by control system 140. For example, local beacon 230 may be a low-energy Bluetooth (“Bluetooth LE”) device, such that a proximity to local beacon 230 can be calculated from the received beacon signal at a distance of up to approximately 150 feet from local beacon 230, according to protocols established in an iBeacon application programming interface (“API”) available through Apple Inc., 1 Infinite Loop Cupertino, California 95014. Alternatively, local beacon 230 is configured to implement any suitable type of wireless beacon signal from which a proximity can be calculated. For example, control system 140 is programmed to detect bounded operational area 220 by storing a value representative of a predetermined radius 222 of bounded operational area 220, wirelessly detecting the proximity to local beacon 230 located within bounded operational area 220, and preventing apparatus 100 from traversing away from local beacon 230 beyond predetermined radius 222.

Additionally or alternatively, in some examples, control system 140 is programmed to detect bounded operational area 220 with reference to GPS signals 242 that are emitted from a plurality of GPS satellites 240 and wirelessly detectable by control system 140. For example, control system 140 is programmed to detect bounded operational area 220 by storing geographical coordinates that define bounded operational area 220, wirelessly detecting GPS signals 242, and preventing apparatus 100 from traversing outside bounded operational area 220 by comparing a geographical location derived from detected GPS signals 242 to the stored geographical coordinates.

Additionally or alternatively, in some examples, control system 140 is programmed to detect bounded operational area 220 with reference to a plurality of radio frequency (RF)-enabled boundary markers 250 located along a perimeter of bounded operational area 220. RF-enabled boundary markers 250 are each configured to emit a short-range RF signal including a unique identifier of the marker. The signal is either actively powered (e.g., by a battery coupled to the marker 250) and periodic, or passively powered by a strobe emitted by an RF module of control system 140. Control system 140 is programmed to detect bounded operational area 220 via short-range wireless interactions with the plurality of RF-enabled boundary markers 250. For example, control system 140 is configured to store a relative location of each RF-enabled boundary marker 250, wirelessly detect a signal from at least one of RF-enabled boundary markers 250, extract the unique identifier of the at least one RF-enabled boundary marker 250, and prevent apparatus 100 from traversing outside bounded operational area 220 based on the stored relative location of the identified at least one RF-enabled boundary marker 250.

Alternatively, control system 140 is programmed to detect bounded operational area 220 in any suitable fashion that enables apparatus 100 to function as described herein.

In some cases, environment 200 includes impassable obstacles 260 (e.g., fences or walls) located within bounded operational area 220. In some examples, control system 140 is programmed to navigate apparatus 100 around detected obstacles 260. For example, control system 140 is programmed to detect obstacles 260 located within bounded operational area 220 based on feedback from at least one ultrasound sensor included in control system 140. Additionally or alternatively, control system 140 is programmed to detect obstacles 260 located within bounded operational area 220 based on feedback from at least contact sensor included in control system 140. Additionally or alternatively, control system 140 is programmed to detect obstacles 260 located within bounded operational area 220 in any suitable fashion that enables apparatus 100 to function as described herein.

In some examples, control system 140 includes additional sensors (not individually shown) configured to monitor a status of various components of apparatus 100. For example, control system 140 includes sensors that monitor one or more of: whether wheels 120 are rotating; whether sweep assembly 150 is rotating; whether roller sweep assembly 150 is elevated or lowered; whether tiller assembly 170 is retracted or deployed; and whether receptacle 112 is full to capacity. Feedback from these sensors is monitored to detect fault conditions, for example, jamming of wheels 120, sweep assembly 150, or vibrating bottom wall 114, or a need to empty receptacle 112 to enable collection of more objects 212.

In some examples, apparatus 100 includes an on-board battery (for example, battery 532 shown in FIG. 5) that distributes power to all powered elements of the apparatus as described above. In other examples, at least one powered element includes a dedicated battery (not shown) local to the element.

In some examples, control system 140 is programmed to communicate wirelessly with a computer-executable application on a user computing device 270. For example, control system 140 is configured to communicate with the computer application using a Bluetooth connection. The computer application may be used to upload operational parameters to control system 140, such as but not limited to: selection of method for detecting the perimeter of bounded operational area 220; relative locations of RF-enabled boundary markers 250; selection of stored surface-coverage algorithm or upload of new surface coverage algorithm; and scheduling of operational times and/or down times. In addition, the computer application may be used to report operating conditions, statistics, and/or faults detected by control system 140, such but not limited to: current location; log of recent operations; fault status of wheels 120, sweep assembly 150, and vibrating bottom wall 114; raised versus lowered status of sweep assembly 150; deployed versus retracted status of tiller assembly 170; battery charge level; and fill level of receptacle 112.

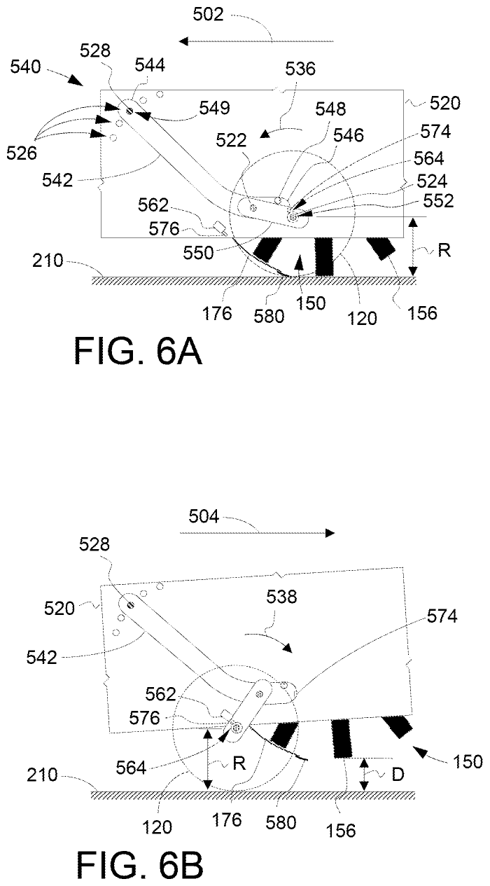

FIG. 5 is a perspective view of another example embodiment of an object-gathering apparatus 500. FIGS. 6A and 6B are side views of a rear portion of apparatus 500 in a forward-moving configuration and a backward-moving configuration, respectively.

Apparatus 500 includes many features similar or identical to apparatus 100 described above, including for example chassis 110, receptacle 112, wheels 120, sweep assembly 150 (for example, including sweep assembly motor 154, shown in FIG. 1, and bristles 156), and ramp 176. In particular, apparatus 500 is likewise configured to transfer objects from surface 210 into receptacle 112 by mechanical action on the objects in response to rotation of sweep assembly 150, without use of negative pressure or vacuum suction or water jets to move the objects as in conventional systems. As with apparatus 100, the sweep assembly 150 of apparatus 500 is configured to rotate in an opposite direction to a drive direction 536 of rotation of the wheels 120 when the apparatus is moving in a forward direction 502.

In the example, apparatus 500 can also include additional features described above with respect to apparatus 100, such as tiller assembly 170 and screen 180 (not shown in FIGS. 5. 6A. and 6B). For example, the screen 180 can be interdigitated with the bristles 156 as described above. The chassis 110 of apparatus 500 can also include a housing 520 configured to enclose an upper portion of the sweep assembly 150, for example.

In the example, in contrast to apparatus 100, apparatus 500 does not include control system 140 (shown in FIG. 1) programmed to detect, and guide the apparatus within, the bounded operational area. Instead, apparatus 500 includes a handle 510 to enable a human operator (not shown) to manually guide the apparatus 500 over the surface 210 to collect the objects of interest. Further in the example, wheels 120 of apparatus 500 are not driven by an on-board power source such as wheel motors 122 (shown in FIG. 1). Instead, the handle 510 is configured to enable the human operator to provide a motive force to manually move the apparatus 500 over the surface 210. However, the use of an on-board power source to drive the wheels 120, in combination with guidance or additional motive force from a human operator via the handle 510, is also contemplated.

In the example embodiment, apparatus 500 further does not include first and second suspension assemblies 128, 130 (shown in FIG. 1). For example, in many applications the human operator can maneuver the apparatus 500 around difficult terrain via the handle 510, without need for the rocker arm suspension described above. In some examples, the apparatus 500 includes two front wheels 120 and two rear wheels 120 (one of each of which is visible in FIG. 5, with corresponding front and rear wheels 120 laterally across from their counterparts, on the other side of the apparatus 500). The front wheels 120 can be coupled to the chassis 110 by a simple axle, while the rear wheels 120 (i.e., the two wheels closest to the handle 510) can each be coupled to the chassis via a respective linkage assembly as discussed below. The axles of both rear wheels 120 can be aligned along a longitudinal axle axis A. However, the use of first and second suspension assemblies 128, 130 or other coupling methods for the wheels 120 is also contemplated.

Embodiments of apparatus 500 can provide utility, relative to apparatus 100, in environments in which boundaries or obstacles are regularly re-located (which in some cases can limit an ability of the self-guidance system to learn to cover an entire area where objects are to be collected), or environments in which a relatively large amount of difficult terrain must be covered (which tends to drain the on-board power source if the wheels are driven by the on-board power source). Additionally, in some applications, embodiments of apparatus 500 can provide a reduced cost and reduced manufacturing complexity relative to embodiments of apparatus 100, due for example to absence of the control system 140 or of a powered drive system for the wheels 120. However, embodiments that include handle 510 in combination with either or both of the control system 140 or the powered drive system or rocker arm suspension for the wheels 120 are also contemplated.

In the example embodiment, the apparatus 500 includes a power supply 530 configured to rotate the sweep assembly 150. The power supply 530 can include a rechargeable battery 532 that can be removably inserted into a battery clip 534, and the battery clip 534 can be wired to supply power from the rechargeable battery 532 to the sweep assembly motor 154 (shown in FIG. 1). In the example embodiment, the battery clip 534 is affixed to the housing 520 and is accessible from an exterior of the apparatus 500, which can facilitate a quick swap out of the battery 532 to enable continued field operation over a long time duration. The rechargeable battery 532 can be a standard off-the-shelf lithium-ion battery compatible with handheld power tools (e.g., rated for 18-21 volts and 2-3 ampere-hours), which facilitates an ease of replacing, charging, and maintaining the battery. However, other types of batteries or on-board power sources are also contemplated for power supply 530.

In some embodiments, the wheels 120 are independent of the power supply 530. For example, the wheels 120 can be drivable solely by manual power, such as via a human operator pushing the handle 510, which can advantageously reserve battery life for the sweep assembly 150. In certain embodiments, the sweep assembly 150 can be the sole non-manually powered feature of the apparatus 500, which significantly reduces a total power consumption by apparatus 500 and increases a use time of the on-board power supply 530 between charges, relative to apparatus 100 and some known object collecting machines. In some embodiments, the use of the rechargeable battery 532, in combination with manually powered movement of the wheels 120 (such as via the handle 510) as described herein, enables the rechargeable battery 532 to drive the sweep assembly 150 for effective collection of the objects of interest over an extended period of time as compared to known object collecting machines.

With particular reference to FIG. 6A, in the example embodiment, apparatus 500 further includes a proximity adjustment mechanism 540 configured to adjust a vertical position of an axle 524 of each rear wheel 120 relative to the housing 520. For example, each rear wheel 120 can be mounted on a separate axle 524, rather than both on a single axle extending transversely across the apparatus 500, to avoid interference of such a single angle with the sweep assembly 150. Because the axle 524 is always positioned above the surface 210 by a distance determined by a radius R of the wheel 120, and a rotational axis (not shown) of the sweep assembly 150 is vertically fixed relative to the housing 520, a human operator can use the proximity adjustment mechanism 540 to manually adjust the proximity of the bristles 156 to the surface 210. In the view of FIG. 6A, the wheel 120 is hidden (shown in dashed lines) to better illustrate the proximity adjustment mechanism 540. Rotation of wheel 120 in a drive direction 536 (counter-clockwise in the view of FIG. 6A) corresponds to apparatus 500 traveling in a forward direction 502, while rotation of wheel 120 in a reverse direction 538 (clockwise in the view of FIGS. 6A and 6B) corresponds to apparatus 500 traveling in a backward direction 504 (shown in FIG. 6B).

Proximity adjustment mechanism 540 can be implemented by a first linkage element 542 that extends from a first end 544 to a second end 546. For example, in the illustrated embodiment, first linkage element 542 is an elongated, rigid member with a slightly curved shape. However, other implementations for first linkage element 542 are also contemplated.

First linkage element 542 can be coupled to the chassis by, and configured to rotate around, a first pin member 522. Rotation of first linkage element 542 in a first direction (clockwise in the view of FIG. 6A) about first pin member 522 causes second end 546 to move vertically downward relative to the housing 520, while rotation of first linkage element 542 in an opposite second direction (counter-clockwise in the view of FIG. 6A) about first pin member 522 causes second end 546 to move vertically upward relative to the housing 520. Other implementations for enabling vertical movement of second end 546 relative to housing 520 are also contemplated.

Second end 546 can be configured to vertically position axle 524 relative to housing 520, that is, second end 546 can be coupled to axle 524 such that vertical movement of second end 546 causes a corresponding vertical movement of axle 524. The coupling between second end 546 and axle 524 can be direct or indirect. For example, in the embodiment illustrated in FIGS. 6A and 6B, axle 524 is coupled indirectly to second end 546 via a second linkage element 550. More specifically, second linkage element 550 can be coupled to first linkage element 542 by, and configured to rotate around, the first pin member 522. Moreover, axle 524 can be coupled to second linkage element 550. For example, axle 524 can extend through an axle opening 552 in second linkage element 550 and be configured for rotation within axle opening 552.

In a first mode of adjustment, which can occur when the apparatus is in the forward-moving configuration shown in FIG. 6A, second end 546 of first linkage element 542 bears against second linkage element 550, such that axle opening 552 is constrained to move vertically with second end 546. For example, proximity adjustment mechanism 540 can include a rear stop 548 rigidly affixed to second end 546 of first linkage element 542, and rear stop 548 bears directly against second linkage element 550. As a result, movement of second end 546 vertically downward relative to the housing 520 causes axle opening 552 to correspondingly move vertically downward relative to the housing 520, while movement of second end 546 vertically upward relative to the housing 520 causes axle opening 552 to correspondingly move vertically upward relative to the housing 520. Second linkage element 550 can be advantageously further configured to implement a second mode of vertical positioning of the axle 524 relative to the housing 520, as will be discussed in more detail subsequently. However, other implementations of the indirect coupling between second end 546 and axle 524 are also contemplated.

Proximity adjustment mechanism 540 can further include a locking mechanism 528 configured to secure first linkage element 542 in position relative to housing 520. For example, a human operator can manually disengage locking mechanism 528 to free first linkage element 542 for rotation relative to housing 520 about first pin member 522, manually adjust a vertical position of second end 546 (and thus of axle 524) relative to the housing 520, and then manually reengage locking mechanism 528 to secure first linkage element 542 (and thus axle 524) in the adjusted vertical position.

In the illustrated embodiment, proximity adjustment mechanism 540 further includes a locking opening 549 defined in and extending through first end 544 of first linkage element 542, as well as a plurality of adjustment openings 526 defined in housing 520. Each of the adjustment openings 526 can be positioned to register with the locking opening 549 at a corresponding orientation of first linkage element 542 about first pin member 522, and locking mechanism 528 can be implemented as, for example, a pin insertable through locking opening 549 aligned with any one of the adjustment openings 526. For example, a human operator can simply pull out the pin to disengage locking mechanism 528 from locking opening 549 registered with a first of the adjustment openings 526, re-orient first linkage element 542 to register the locking opening 549 with a second of the adjustment openings 526, and then insert the pin into the registered openings to lock the first linkage element 542 in the new orientation. The discrete positions of the adjustment openings 526 correspond to discrete vertical positions, relative to housing 520, at which axle 524 can be locked. Other implementations of locking mechanism 528 are also contemplated.

Proximity adjustment mechanism 540 enables a simple manual adjustment by a human operator to adjust the height of the sweep assembly relative to the surface 210, thereby improving an efficiency of object collection using the apparatus 500 across different types or environmental conditions of the surface. However, implementations of apparatus 500 that do not include proximity adjustment mechanism 540 are also contemplated.

With reference to FIGS. 6A and 6B, and as noted above, second linkage element 550 can be advantageously further configured to implement a second mode of vertical positioning of the axle 524 relative to the housing 520. More specifically, the second mode mechanically raises the sweep assembly 150, creating a clearance distance D between the bristles 156 and the surface 210, in response to a human operator pulling the apparatus in the backward direction 504. More specifically, collection of objects by the sweep assembly 150 can be inefficient while the apparatus 500 is being pulled in the backward direction 504 via the handle 510, and the clearance distance D prevents unwanted contact or interference by the bristles 156 and the ramp 176 against the surface 210 (for example, uneven terrain, grass or debris on the surface, etc.), for example while the human operator is pulling the apparatus 500 backward to re-position the apparatus for a return to forward movement over a different portion of the surface 210. The second mode also mechanically lowers the sweep assembly 150 from the raised position, returning the bristles 156 to proximity with the surface 210, in response to a human operator again pushing the apparatus in the forward direction 502.

In the example embodiment, second linkage element 550 rotates between two orientations about first pin member 522 to implement the second mode. In a first orientation, corresponding to the forward-moving configuration shown in FIG. 6A, second linkage element 550 is oriented to bear against rear stop 548 (which can be coupled to the second end 546 of first linkage element 542 in a non-limiting example). In the forward-moving configuration, the bristles 156 of sweep assembly 150 are positioned in proximity to the surface 210, with a degree of proximity determined by proximity adjustment mechanism 540. In a second orientation, corresponding to the backward-moving configuration shown in FIG. 6B, second linkage element 550 is oriented to bear against a forward stop 562. For example, the forward stop 562 can be affixed to housing 520 and positioned to bear against second linkage element 550 in the backward-moving configuration. In the backward-moving configuration, the vertical position of axle opening 552 defined in second linkage element 550 is significantly lower, relative to housing 520, than in the forward-moving configuration. Because the axle 524 (which is constrained to move vertically with the axle opening 552) is always positioned above the surface 210 by a distance determined by a radius R of the wheel 120, shifting axle 524 downward relative to the housing 520 elevates the housing relative to the surface 210, creating the clearance distance D between the bristles of sweep assembly 150 and the surface 210.

In the example, the apparatus 500 further includes a ratchet mechanism 564 configured to cause second linkage element 550 to transition from the forward-moving configuration to the backward-moving configuration. Moreover, ratchet mechanism 564 can be configured to actuate mechanically in response to the human operator transitioning from pushing handle 510 in the forward direction 502 to pulling the handle 510 in the backward direction 504. In other words, ratchet mechanism 564 can be configured to operate without requiring the human operator to directly manipulate elements (or control features directly attached to elements) of ratchet mechanism 564.

For example, ratchet mechanism 564 can be configured to constrain wheel 120 from rotating in the reverse direction 538 in response to apparatus 500 being pushed in the forward direction 502. When the human operator subsequently pulls the apparatus 500 in the backward direction 504, ratchet mechanism 564 prevents wheel 120 from rotating in the reverse direction 538. As a result of wheel 120 being locked against rotation, the pull force in the backward direction 504 causes second linkage element 550 to rotate away from the forward-moving configuration (shown in FIG. 6A) and towards the backward-moving configuration (shown in FIG. 6B). Moreover, ratchet mechanism 564 can be configured to automatically release the wheel 120 for rotation in the reverse direction 538 in response to second linkage element 550 transitioning to the backward-moving configuration. In other words, after the initial pulling of handle 510 by the human operator transitions second linkage element 550 to the backward-moving configuration and releases ratchet mechanism 564, wheel 120 will then turn smoothly in reverse direction 538 as the human operator continues to pull the handle 510 in the backward direction 504.

In addition, ratchet mechanism 564 can be configured to cause second linkage element 550 to transition from the backward-moving configuration to the forward-moving configuration, again without requiring the human operator to directly manipulate elements (or control features directly attached to elements) of ratchet mechanism 564. For example, ratchet mechanism 564 can be configured to constrain wheel 120 from rotating in the drive direction 536 in response to apparatus 500 being pulled in the backward direction 504. When the human operator subsequently pushes the apparatus 500 in the forward direction 502, ratchet mechanism 564 prevents wheel 120 from rotating in the drive direction 536. As a result of wheel 120 being locked against rotation, the push force in the forward direction 502 causes second linkage element 550 to rotate away from the backward-moving configuration (shown in FIG. 6B) and towards the forward-moving configuration (shown in FIG. 6A). Moreover, ratchet mechanism 564 can be configured to automatically release the wheel 120 for rotation in the drive direction 536 in response to second linkage element 550 transitioning to the forward-moving configuration. In other words, after the initial pushing of handle 510 by the human operator transitions second linkage element 550 to the forward-moving configuration and releases ratchet mechanism 564, wheel 120 will then turn smoothly in drive direction 536 as the human operator continues to push the handle 510 in the forward direction 502.

FIG. 6C is a schematic view, taken normal to longitudinal axle axis A (shown in FIG. 5), of a portion of an example implementation of ratchet mechanism 564. In the example embodiment, ratchet mechanism 564 can include first and second ratchet gears 566 and 568 affixed to axle 524. Ratchet gears 566, 568 are oriented normal to, and positioned sequentially along, the longitudinal axle axis A (shown in FIG. 5). Ratchet gear 566 includes gear teeth having asymmetric edges that define notches 570 therebetween, and ratchet gear 568 includes gear teeth having asymmetric edges that define oppositely oriented notches 572 therebetween.

With reference to FIGS. 6A-6C, in the example embodiment, ratchet mechanism 564 further includes a rear pawl 574 and a forward pawl 576 coupled directly or indirectly to the housing 520. For example, rear pawl 574 can be affixed to second end 546 of first linkage element 542, and positioned (relative to the longitudinal axle axis A) at a same longitudinal spacing from housing 520 as ratchet gear 566. Similarly, forward pawl 576 can be affixed to housing 520 (either directly, or indirectly via attachment to forward stop 562, for example), and positioned (relative to the longitudinal axle axis A) at a same longitudinal spacing from housing 520 as ratchet gear 568.

Notches 570 can be shaped to receive rear pawl 574 therein. More specifically, when second linkage element 550 is in the forward-moving configuration (FIG. 6A), the asymmetric shape of the teeth of ratchet gear 566 enables the ratchet gear 566 (and, thus, axle 524) to turn smoothly in the drive direction 536, but any slight rotation of wheel 120 in the reverse direction 538 causes rear pawl 574 to engage one of notches 570, locking wheel 120 against further rotation in the reverse direction 538. Accordingly, if the human operator transitions from pushing handle 510 in the forward direction 502 to pulling handle 510 in the backward direction 504, the wheel 120 being locked against turning in the reverse direction 538 will cause the pulling force to transition second linkage element 550 to the backward-moving configuration (FIG. 6B). The transition also causes rear pawl 574 to disengage from the notch 570, freeing wheel 120 for rotation in the reverse direction 538 in response to a continued pulling motion on the handle 510.

Likewise, notches 572 can be shaped to receive forward pawl 574 therein. More specifically, when second linkage element 550 is in the backward-moving configuration (FIG. 6B), the asymmetric shape of the teeth of ratchet gear 568 enables the ratchet gear 568 (and, thus, axle 524) to turn smoothly in the reverse direction 538, but any slight rotation of wheel 120 in the drive direction 536 causes forward pawl 576 to engage one of notches 572, locking wheel 120 against further rotation in the drive direction 536. Accordingly, if the human operator transitions from pulling handle 510 in the backward direction 504 to pushing handle 510 in the forward direction 502, the wheel 120 being locked against turning in the drive direction 536 will cause the pushing force to transition second linkage element 550 to the forward-moving configuration (FIG. 6A). The transition also causes forward pawl 576 to disengage from the notch 572, freeing wheel 120 for rotation in the drive direction 536 in response to a continued pushing motion on the handle 510.

Accordingly, the example embodiment, ratchet mechanism 564 actuates mechanically, in response to the human operator transitioning from pushing to pulling the handle 510 or vice versa, to raise the sweep assembly 150 during backward motion and re-lower the sweep assembly 150 during forward motion, without requiring the human operator to directly manipulate elements (or control features directly attached to elements) of ratchet mechanism 564, and without requiring a powered actuator that would reduce an amount of time the power supply 530 (shown in FIG. 5) can be used to drive the sweep assembly 150 before requiring a recharge. Other implementations of ratchet mechanism 564 are also contemplated.

In the example embodiment, apparatus 500 can include an embodiment of ramp 176 that includes a flexible endpiece 580. In particular, flexible endpiece 580 is located at a distal end of ramp 176, proximate to the surface 210. As apparatus 500 moves in the forward direction 502, flexible endpiece 580 is configured to flex in a rearward direction to allow objects on surface 210 to pass underneath ramp 176 and into a position for collection by sweep assembly 150. For example, flexible endpiece 580 can be formed from a rubber material. The use of flexible endpiece 580 enables other portions of ramp 176 to be constructed from one or more less flexible materials, such as a hard plastic, that provide a sturdier ramp structure. Flexible endpiece 580 can be fastened at the distal end of ramp 176 in any suitable fashion. Other implementations of ramp 176, with or without flexible endpiece 580, are also contemplated.

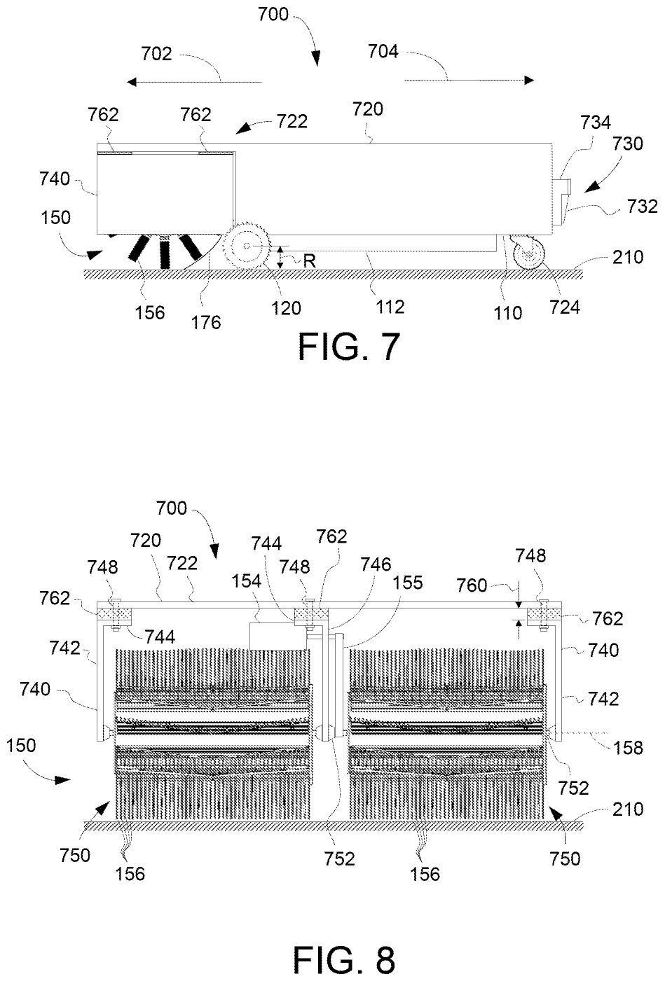

FIG. 7 is a perspective view of another example embodiment of an object-gathering apparatus 700. FIG. 8 is a front view of apparatus 700.

Apparatus 700 includes many features similar or identical to apparatus 100 described above, including for example chassis 110, receptacle 112, wheels 120, sweep assembly 150 (for example, including sweep assembly motor 154 and bristles 156), ramp 176, and control system 140 (shown in FIG. 1) programmed to detect, and guide the apparatus within, the bounded operational area. In particular, apparatus 700 is likewise configured to transfer objects from surface 210 into receptacle 112 by mechanical action on the objects in response to rotation of sweep assembly 150, without use of negative pressure or vacuum suction or water jets to move the objects as in conventional systems. Control system 140 can be programmed to communicate wirelessly with a computer-executable application on a user computing device 270 (shown in FIG. 4), as discussed above. For example, control system 140 can be configured to communicate with the computer application using a Bluetooth connection. The computer application may be used for one or more of communicating parameters related to self-guidance algorithms or maps for the apparatus 700, actively steering the apparatus 700, or other purposes discussed above with respect to FIG. 4. Additional functionality is also contemplated for the computer-executable application on the user computing device 270 interacting with the control system 140.

In the example, apparatus 700 can also include additional features described above with respect to apparatus 100, such as tiller assembly 170 and screen 180 (not shown in FIGS. 7 and 8). For example, the screen 180 can be interdigitated with the bristles 156 as described above. The chassis 110 of apparatus 500 can also include a housing 720 configured to enclose the control system 149, the receptacle 112, and an upper portion of the sweep assembly 150, for example. Housing 720 can also be referred to as a “first” housing 720 to distinguish housing 720 from sweep assembly housing 740 (discussed in detail below).

Embodiments of apparatus 700 can provide utility, relative to apparatus 100 or apparatus 500, in indoor environments in which surface 210 is a smooth, regular surface and an amount and size of non-object debris is expected to be limited (as compared to a natural outdoor surface such as turf or gravel). For example, wheels 120 of apparatus 700 can include solely two front wheels 120 (one of which is visible in FIG. 7, the other of which is located on an opposite side of the housing 720 from the visible wheel), and a single rear caster wheel 724, and apparatus 700 further does not include first and second suspension assemblies 128, 130 (shown in FIG. 1).

Similar to apparatus 100, the two front wheels 120 can be driven by an on-board power source such as respective wheel motors 122 (shown in FIG. 1). As noted above, the use of a separately controlled wheel motor 122 for each wheel 120 can enhance a maneuverability of apparatus 100. For example, changing the forward direction of travel of apparatus 700 can be accomplished by driving wheel motors 122 on opposing sides of chassis 110 in opposite rotational directions, which avoids a need for a steering system to change direction. The single rear caster wheel 724 can be affixed to the chassis in a position that supports a rear portion of apparatus 700 above the surface and enables substantially free movement of the apparatus 700 in response to powered rotation of the front wheels 120, for example as commanded by the control system 140 (shown in FIG. 1) to steer apparatus 700. In other words, rear caster wheel 724 is not coupled to the at least one wheel motor 122. The use of a single wheel motor 122 to drive both front wheels 120, or of suspension assemblies or other wheel types or coupling methods for the wheels 120, is also contemplated. In some applications, embodiments of apparatus 700 can provide a reduced cost and reduced manufacturing complexity relative to embodiments of apparatus 100, due for example to reduced wheel and suspension complexity.

In contrast to apparatus 100, the sweep assembly 150 of apparatus 700 is configured to rotate in the same direction as the wheels 120 when the apparatus is moving in a forward direction 702. For example, in contrast to apparatus 100, sweep assembly 150, ramp 176, and screen 180 (shown in FIG. 1) can be placed forward of receptacle 112. More specifically, using counter-rotation of sweep assembly 150 during forward motion of apparatus 700 to “pop” objects from the surface 210, as discussed above with respect to apparatus 100, may not be as necessary to collect the objects from a smooth, regular indoor surface 210 with apparatus 700. Rotation of sweep assembly 150 in the same direction as the wheels 120 can advantageously reduce a power required by apparatus 700 to drive sweep assembly 150, relative to apparatus 100, due to a reduction of interference of bristles 156 with the surface 210 that can be produced by counter-rotation of sweep assembly 150 by apparatus 100.

In the example embodiment, apparatus 700 includes a power supply 730 configured to rotate the sweep assembly 150 and drive one or more wheel motors 122 (shown in FIG. 1). The power supply 730 can include a rechargeable battery 732 that can be removably inserted into a battery clip 734, and the battery clip 734 can be wired to supply power from the rechargeable battery 532 to the sweep assembly motor 154 and the one or more wheel motors (shown in FIG. 1). In the example embodiment, the battery clip 734 is affixed to the housing 720 and is accessible from an exterior of the apparatus 700, which can facilitate a quick swap out of the battery 732 to enable continued field operation over a long time duration. The rechargeable battery 732 can be a standard off-the-shelf lithium-ion battery compatible with handheld power tools (e.g., rated for 18-21 volts and 2-3 ampere-hours), which facilitates an ease of replacing, charging, and maintaining the battery. However, other types of batteries or on-board power sources are also contemplated for power supply 730.

In some embodiments, the use of the rechargeable battery 732, in combination with use of apparatus 700 on an even, smooth, regular surface, as described herein, enables the rechargeable battery 732 to drive the sweep assembly 150, the front wheels 120, and the control system 140 (shown in FIG. 1) over an extended period of time as compared to known object collecting machines.

In the example embodiment, sweep assembly 150 is coupled to chassis 110 via a sweep assembly housing 740. For example, sweep assembly 150 can be suspended from sweep assembly housing 740. In some implementations, sweep assembly housing 740 can include a pair of sidewalls 742 extending along a vertical direction on opposing sides of apparatus 700, and sweep assembly 150 can be coupled to sidewalls 742. For example, sweep assembly 150 can include a shaft 752 that defines the longitudinal axis of rotation 158 of sweep assembly 150, and opposing ends of shaft 752 can be rotationally coupled to respective sidewalls 742, for example via respective bearings (not numbered). Other methods for coupling sweep assembly 150 to sweep assembly housing 740 are also contemplated.

In the example embodiment, sweep assembly housing 740 further includes a midwall 746 positioned between the pair of sidewalls 742 and configured to provide additional support for sweep assembly 150. For example, shaft 752 can extend through an opening defined in and extending through midwall 746. For example, a bearing 754 can be positioned in the opening defined in midwall 746 to facilitate rotation of the shaft 752 relative to midwall 746. To avoid interference of bristles 156 with midwall 746, sweep assembly 150 can include two subassemblies 750 affixed to shaft 752 on opposing sides of midwall 746. Each subassembly 750 can include a subset of the bristles 156 of sweep assembly 150. However, embodiments of sweep assembly housing 740 that do not include midwall 746 are also contemplated.

In the example embodiment, sweep assembly motor 154 is mounted on midwall 746, just behind a rotational path of bristles 156, and drive belt 155 extends adjacent to midwall 746 from a drive shaft of sweep assembly motor 154 to shaft 752. This placement of sweep assembly motor 154 can facilitate a short, stable drive path for sweep assembly 150 and a compact vertical profile for apparatus 700. However, other placements for sweep assembly motor 154 and other drive path arrangements between sweep assembly motor 154 and shaft 752 are also contemplated.

Sweep assembly housing 740 can be coupled to chassis 110 and configured for vertical adjustment relative to the chassis 110. More specifically, the vertical adjustability of sweep assembly housing 740 relative to chassis 110 facilitates adjusting a proximity of bristles 156 to the surface 210. Sweep assembly housing 740 can be coupled to housing 720 and extend therefrom to at least partially encase sweep assembly 150. For example, as noted above, sweep assembly 150 can be positioned generally in the forward direction 702 with respect to chassis 110. Sweep assembly housing 740 can be coupled to a forward portion 722 of housing 720 and extend therefrom in the forward direction 702 to at least partially encase sweep assembly 150.

In particular, the coupling of sweep assembly housing 740 to forward portion 722 can be configured to enable adjustment of a vertical offset 760 of sweep assembly housing 740 relative to housing 720. Because a distance of forward portion 722 of housing 720 above the surface 210 is determined by a constant radius R of the front wheel 120, adjustment of the vertical offset 760 of sweep assembly housing 740 relative to housing 720 corresponds to adjustment of the vertical position of sweep assembly 150 (and, hence, of bristles 156) relative to the surface 210.

The vertical offset 760 between sweep assembly housing 740 and chassis housing 720 can be implemented by one or more spacers 762 coupled between sweep assembly housing 740 and chassis housing 720. More specifically, a thickness of the spacers 762 determines the vertical offset 760, and a human operator can select and install spacers 762 to achieve a desired corresponding proximity of bristles 156 of sweep assembly 150 to the surface 210. For example, sweep assembly housing 740 can include a lip 744 extending transversely from a top portion of each sidewall 742, and lip 744 can be coupled to a horizontally extending portion of forward portion 722. The one or more spacers 762 can be coupled between lip 744 and the horizontally extending portion of forward portion 722. For example, to adjust the proximity of bristles 156 of sweep assembly 150 to the surface 210, the human operator can replace or swap out the one or more spacers 762 for a second set of one or more spacers having a different thickness, in order to improve an efficiency of collection of a given type of object from a given type of surface.

In the example embodiment, lip 744 is affixed to the horizontally extending portion of forward portion 722 via fasteners 748. For example, each fastener 748 can include a bolt and a nut (not numbered). Fasteners 748 can have a length that accommodates a range of thicknesses of spacers 762 inserted between lip 744 and the horizontally extending portion of forward portion 722. For example, spacers 762 can each include an opening defined therein and extending therethrough, sized to receive a width of the fastener 748. The fasteners 748 can be configured for easy manual removal and reinstallation by the human operator to facilitate replacing or swapping out the one or more spacers 762 to implement the vertical adjustment of the proximity of bristles 156 of sweep assembly 150 to the surface 210. Other methods for coupling sweep assembly housing 740 to forward portion 722, or for coupling spacers 762 therebetween, are also contemplated.

In embodiments in which sweep assembly housing 740 includes midwall 746, at least one of the one or more spacers 762 can be coupled between midwall 746 and chassis housing 720, for example to facilitate alignment of shaft 752 extending therethrough. For example, midwall 746 can also include lip 744 extending from a top portion thereof, and one or more additional fasteners 748 can be used to affix the lip 744 of midwall 746 to the horizontally extending portion of forward portion 722. At least one spacer 762 can be coupled between the lip 744 of midwall 746 and the horizontally extending portion of forward portion 722.

Examples of an object-gathering apparatus are described above in detail. The apparatus is not limited to the specific examples described herein, but rather, components of the apparatus may be used independently and separately from other components and environmental elements described herein. For example, the apparatus described herein may be used in a variety of environments, including and without limitation, natural and artificial surfaces, indoors and outdoors, and with any category of objects having a suitable size for collection and retention by the apparatus.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1-22. (canceled)

23. An object-gathering apparatus comprising:
a chassis;
a plurality of wheels coupled to the chassis and configured to traverse a surface;
a receptacle coupled to the chassis;
a battery clip affixed to the chassis and accessible from an exterior of the object-gathering apparatus, wherein a rechargeable battery is removably insertable into the battery clip; and
a sweep assembly coupled to the chassis and configured to transfer objects from the surface into the receptacle by mechanical action on the objects, and without use of negative pressure or vacuum suction acting on the objects during the transfer, in response to powered rotation of the sweep assembly by the rechargeable battery.

24. The object-gathering apparatus according to claim 23, wherein the battery clip is configured to receive a standard off-the-shelf lithium-ion battery compatible with handheld power tools.

25. The object-gathering apparatus according to claim 23, further comprising at least one wheel motor affixed to the chassis and drivingly coupled to at least one of the plurality of wheels, wherein the at least one wheel motor is configured to be driven by the rechargeable battery.

26. The object-gathering apparatus according to claim 25, wherein the plurality of wheels includes a rear caster wheel that is not drivingly coupled to the at least one wheel motor.

27. The object-gathering apparatus according to claim 23, further comprising a sweep assembly housing coupled to the chassis and configured for vertical adjustment relative to the chassis, wherein the sweep assembly is coupled to the chassis via the sweep assembly housing.

28. The object-gathering apparatus according to claim 27, further comprising one or more spacers coupled between the sweep assembly housing and the chassis housing, wherein a thickness of the one or more spacers determines a vertical offset between the sweep assembly housing and the chassis housing.

29. The object-gathering apparatus according to claim 23, further comprising a control system coupled to the chassis and programmed to detect a bounded operational area, and to guide the apparatus within the bounded operational area.

30. An object-gathering apparatus comprising:
a chassis;
a plurality of wheels coupled to the chassis and configured to traverse a surface;
a receptacle coupled to the chassis;
a sweep assembly housing coupled to the chassis and configured for vertical adjustment relative to the chassis; and
a sweep assembly coupled to the sweep assembly housing and configured to transfer objects from the surface into the receptacle by mechanical action on the objects, and without use of negative pressure or vacuum suction acting on the objects during the transfer, in response to rotation of the sweep assembly.

31. The object-gathering apparatus according to claim 30, further comprising a power supply coupled to the chassis and configured to drive the rotation of the sweep assembly.

32. The object-gathering apparatus according to claim 31, wherein the power supply comprises a battery clip affixed to the chassis, and wherein a rechargeable battery is removably insertable into the battery clip.

33. The object-gathering apparatus according to claim 32, wherein the power supply is further configured to drive at least one of the plurality of wheels.

34. The object-gathering apparatus according to claim 30, wherein the vertical adjustment determines a proximity of the sweep assembly to the surface.

35. The object-gathering apparatus according to claim 30, wherein the chassis comprises a chassis housing, and wherein the sweep assembly housing is coupled to the chassis housing and extends therefrom to at least partially encase the sweep assembly.

36. The object-gathering apparatus according to claim 35, further comprising one or more spacers coupled between the sweep assembly housing and the chassis housing, wherein a thickness of the one or more spacers determines a vertical offset between the sweep assembly housing and the chassis housing.

37. The object-gathering apparatus according to claim 36, wherein the one or more spacers are replaceable by a second set of one or more spacers having a different thickness to implement the vertical adjustment.

38. The object-gathering apparatus according to claim 36, wherein the chassis housing comprises an extending portion, wherein the sweep assembly housing comprises a pair of sidewalls extending along a vertical direction on opposing sides of the apparatus, and wherein the one or more spacers are coupled between the sidewalls and the extending portion.

39. The object-gathering apparatus according to claim 38, wherein the sweep assembly housing further comprises a midwall positioned between the pair of sidewalls and configured to provide additional support for the sweep assembly.

40. The object-gathering apparatus according to claim 39, wherein the sweep assembly comprises a shaft that defines a longitudinal axis of rotation of the sweep assembly, wherein the shaft comprises opposing ends rotationally coupled to the sidewalls, wherein the shaft extends through an opening defined in the midwall, and wherein the sweep assembly comprises two subassemblies affixed to the shaft on opposing sides of the midwall.

41. The object-gathering apparatus according to claim 40, wherein at least one of the one or more spacers is coupled between the midwall and the chassis housing.

42. The object-gathering apparatus according to claim 30, further comprising a control system coupled to the chassis and programmed to detect a bounded operational area, and to guide the apparatus within the bounded operational area.
